(19) United States
(12) Patent Application Publication
(10) Pub. No.: US 2004/0012806 A1
(43) Pub. Date: Jan. 22, 2004

(54) System and method for properly printing image data at a hardcopy device

(75) Inventor: Kazumi Murata, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/199,323

(22) Filed: Jul. 22, 2002

(51) Int. Cl. G06F 3/12; G06F 13/00; G06F 11/00

(52) U.S. Cl. 358/1.14; 358/1.15; 710/15

(57) ABSTRACT

A system and method for printing image data at a hardcopy device includes receiving the image data to be printed from a user, determining if the received image data has at least one predetermined error, and notifying the user if the received image data is determined to have at least one predetermined error. An indication is received from the user whether to print the image data in response to the notification to the user.

### FIELD OF THE INVENTION

The present invention relates generally to image processing, and more particularly to a system and method for printing image data at a hardcopy device.

### BACKGROUND OF THE INVENTION

In a conventional system, a hardcopy device receives a print job from another device, such as a workstation or server, via a network connection. The print job includes image data used by the hardcopy device to print data. In response to the reception of the print job, the hardcopy device processes the received image data and prints the processed image data one or more pages.

On occasion, the data printed by the hardcopy device may not correspond to the print out desired by the user submitting the print job. This error in the print out may result when the computer operated by the user erroneously forms the image data. Alternatively, the image data may be altered or corrupted during the transmission of the print job from the user's workstation to the hardcopy device. This transmission error may occur because of network congestion or some trouble in the operation of the network. It is also possible that there is an error in the image data that resulted when the controller of the hardcopy device received the image data from the network. As a result of these errors, the images and/or text of a document may be printed out improperly, causing the user to reprint the document and waste paper and toner.

### SUMMARY OF THE INVENTION

Briefly, in one aspect of the invention, a method for printing image data at a hardcopy device includes receiving the image data to be printed from a user, determining if the received image data has at least one predetermined error, and notifying the user if the received image data is determined to have at least one predetermined error. An indication is received from the user whether to print the image data in response to the notification to the user.

In another aspect of the present invention, the image data is stored in a buffer if the image data is determined to have at least one predetermined error.

In yet another aspect of the present invention, the image data is printed if the indication received from the user approves the printing of the image data, or the image data has no predetermined errors.

### BRIEF DESCRIPTION OF THE DRAWINGS

FIG. 1 is a block diagram of an image processing system consistent with the present invention.

FIG. 2 is a block diagram of a hardcopy device in the image processing system of FIG. 1.

FIG. 3 is a flow diagram of a print control process consistent with the present invention.

### DETAILED DESCRIPTION OF THE PREFERRED EMBODIMENT

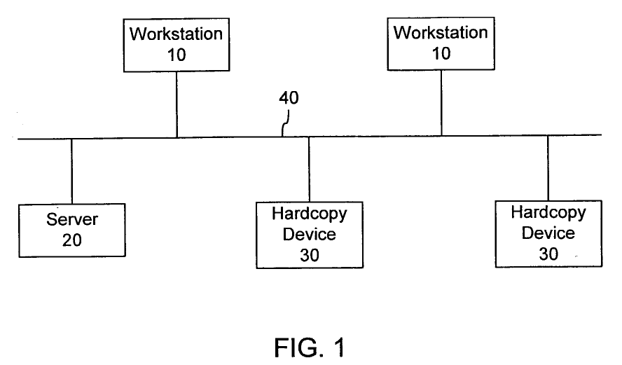

FIG. 1 is a block diagram of an image processing system consistent with the present invention. As shown in FIG. 1, the communication system includes a pair of workstations 10, a server 20, a pair of hardcopy devices 30 and a network. Each of the workstations 10, the server 20 and each of the hardcopy devices 30 are coupled to the network 40. The network 20 may be implemented as a local network, such as a LAN, or as a public network, such as the Internet. Although only a pair of workstations 10 and hardcopy devices 30 are shown, it should be understood that the image processing system may include any number of workstations 10 and hardcopy devices 30.

The workstation 10, which may be a PC or a server, includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the workstation 10 provides a two-way data communication coupling via a network link to the network 40. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 40.

If the network is implemented as the Internet, the workstation 10 or server can transmit a requested code for an application program through the Internet, an ISP, the local network and the communication interface. The received code can be executed by the CPU in the workstation or server as it is received, stored in the storage device, or stored in some other non-volatile storage for later execution. In this manner, a user at the workstation or server may obtain application code in the form of a carrier wave. The server 20 may be implemented in the same manner as the workstation 10, plus any other functionality that may be needed to manage the operation of the network 40.

In operation, the workstations 10 communicate with the hardcopy devices 30 via the network 40 or via a more direction connection, such as the USB. This communication enables the workstation 10 to request the hardcopy device 30 to perform a function, such as print a document or send or receive a fax. In addition, the workstation 10 can request information from the hardcopy device 30.

The hardcopy device 30 is a device which can perform the functions of one or more devices, such as a printer, a fax machine, a copier, a plotter, a scanner or any other functional device that generates hardcopies of images or text. If the hardcopy device 30 performs the functions of at least two devices, the hardcopy device 30 may be referred to as a multi-function peripheral (MFP).

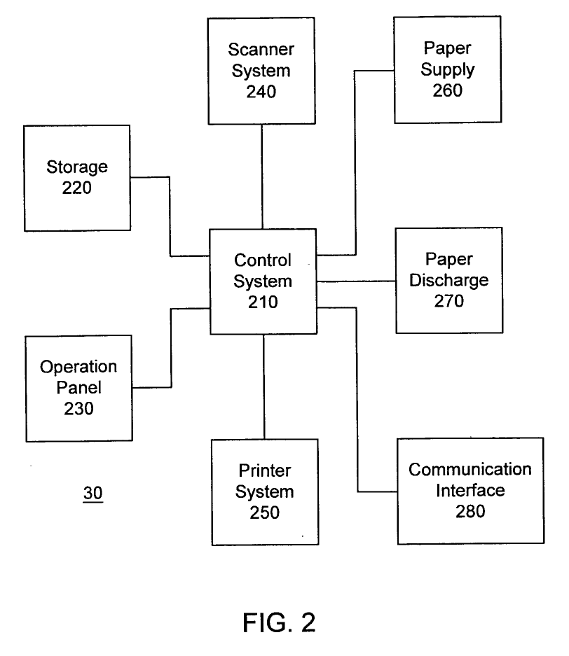

FIG. 2 is a block diagram of a hardcopy device in the image processing system of FIG. 1. As shown in FIG. 2, the hardcopy device 30 includes a control system 210, a storage 220, an operation panel 230, a scanner system 240, a printer system 250, a paper supply 260, a paper discharge 270 and a communication interface 280. The control system 210 includes a processor for controlling the operation of the hardcopy device 30 and is couple to each of the other parts of the hardcopy device 30. The storage device 220 stores data received from a workstation 10. The storage device 220 may be implemented as a ROM, a RAM a hard disk drive, or some combination thereof. The storage device also stores programming structure that may be executed by the processor of the control system 210 to control the operation of the hardcopy device 30.

The operational panel 230 allows a user to input instructions directly to the hardcopy device 30 and displays operational and status information. The scanner system 240 reads image data received by the hardcopy device 30, and the printer system 250 executes the printing of image data received by the hardcopy device 30. The paper supply 260 supplies paper or sheets into the hardcopy device upon which the image data is printed, and the paper discharge controls the output of the printed sheet from the hardcopy device 30.

The communication interface 280 provides a two-way data communication coupling via a network link to the network 40. The network link to the network 20 enables the hardcopy device 30 to receive data from and to output data to the workstation 10 and/or the server 20. Instead of a network link, the hardcopy device 30 may use a Universal Serial Bus (USB) to connect to a USB port on the workstation 10.

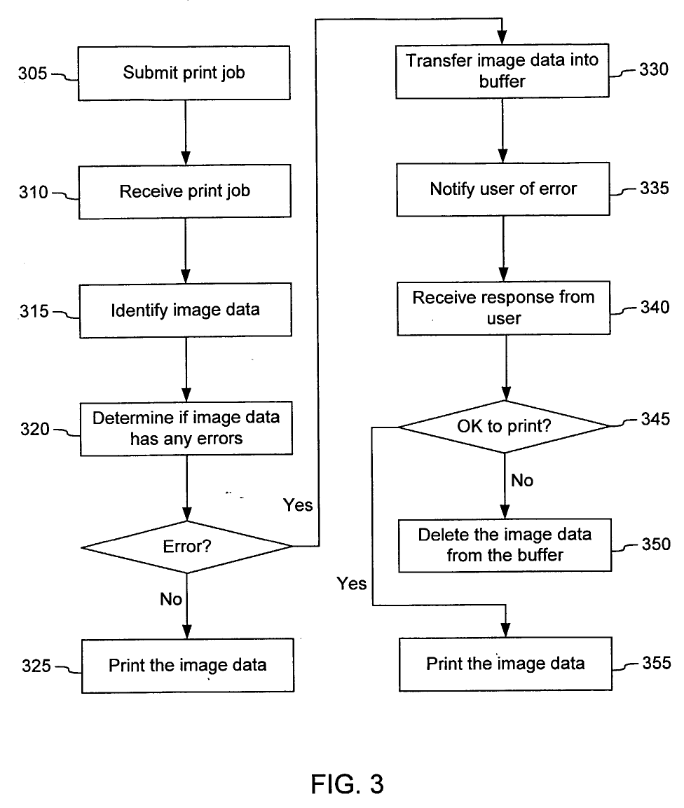

FIG. 3 is a flow diagram of a print control process consistent with the present invention. As shown in FIG. 3, the first step in the print control process is to submit a print job (step 305). The print job may be submitted by a user at a workstation 10 or the server 20. The print job includes the image data to be printed by the hardcopy device 30. The image data includes the data for forming images or text on a sheet, as well as any formatting or print control information specifying the manner in which the data is to be printed, such as the layout, paper source, margins or paper size. In addition to the image data, the print job may include header information that identifies the structure of the image data, the address of the submitter of the print job, and the address of the hardcopy device 30 receiving the print job.

The print job submitted by the user is received by the hardcopy device 30 (step 310). The print job may be received by the communication interface 280 via the network 40. Alternatively, the print job may be received by a direct communication coupling from the workstation 10 or server 20. The submitted print job is stored in the storage 220 of the hardcopy device 30.

The image data in the received print job is then identified (step 315). The image data is identified by the control system 210 from the print job stored in the storage 220. If there are a plurality of print jobs in the storage 220, then the control system may identify the image data at the time the particular print job is ready for processing. Alternatively, the control system may identify the image data at the time the print job is received by the hardcopy device 30.

The identified image data is then analyzed to determine if the image data has any errors (step 320). As described above, there are multiple instances by which the image data may be caused to have errors, including the formation of the image data for the print job by the workstation 10 or server 20, the transmission of the image data through the network 40, and the reception of the image data by the hardcopy device 30.

There are multiple instances for which the image may be determined to have an error. For example, the image data is determined to have an error if the image formed from the image data is all black or all white. This error may occur when all of the image data is corrupted, causing the image data to be all black data or all white data. Another possible error is the improper formatting of the image data. For example, it may be an error if the to be printed image data would result in a single line of data being printed on each page. More generally, it may be an error if there are fewer than a predetermined number of characters or less than a certain percentage of the page being used for a predetermined number of pages. It may also be an error if the to be printed image data has a large number of page breaks, or if there are more than a predetermined number of consecutive page breaks. Other image data errors may also be determined.

To determine whether the image data has any errors, the control system 210 analyzes the identified image data of the print job. To perform the analysis, the control system 210 may include programming and/or hardware structure that enables the control system to identify the errors. The analysis may enable the control system to preview the how the image data will be printed and determine if there are any errors based on the preview. Alternatively, the analysis may be done on the raw image data.

If there is no error in the image data, the image data for the print job is printed (step 325). The control system 220 transfers the image data to the printer system 250, which processes the image data into a print image to be printed on one or more sheets. The paper supply 260 supplies each sheet, and the printer system places the print image on the supplied sheet. The paper discharge 270 controls the output of each printed sheet to an output portion of the hardcopy device 30.

If there is an error in the image data, the image data for the print job is transferred into a buffer (step 330). The buffer may be a private holding buffer in a protected area of the storage 220 separate from the area in the storage 220 that holds the received print jobs.

In addition to storing the image data for the print job in the buffer, the user who submitted the print job is notified of the error (step 335). The notification to the user may merely indicate that there is an error in the image data. Alternatively, the notification may specify the specific error in the image data, such as all of the data being black or the presence of multiple consecutive page breaks. The notification may also include a preview image of what the printed image data would look like, i.e., a print preview. The notification sent to the user may be in the form of an electronic mail message. Alternatively, the notification may be sent in a simple network message format, such as SNMP. The notification sent from the hardcopy device 30 is sent to the user via the communication interface 280.

The notification is received by the user (step 340). The notification is received at the workstation 10 or server 20 at which the user submitted the print job. As described above, the notification received by the user may be in the form of an e-mail message or in some network message format. In response to the received notification, the user may be alerted to the received notification by some visual or audio indicator at the workstation 10 or server 20. For example, a window may appear in the application from which the user submitted the print job. The window may alert the user to the reception of the notification or may include the information provided in the notification.

The user reviews the notification to determine whether or not to proceed with the printing (step 345). As described above, the notification may simply indicate that an error exists or may specifically identify the type of error. In addition, the notification may include a print preview showing the user how the image data will look when printed. The user can determine whether to accept the printing based on the identified error and/or print preview. For example, it may be the intention of the user to have a single line of data on multiple pages, may have wanted to have an all white page, or they may have been errors.

To make the determination of whether the image data should be printed, an indication is sent from the user back to the hardcopy device 30. The indication may be in the same form as the notification sent to the user. To indicate whether or not the image data should be printed, the user may select an icon or button provided in the notification. For example, the notification may be displayed as a window that queries the user whether to print the image data, including a ‘Yes’ and a ‘No’ button. To select the button the user may use a pointing device, such as a mouse, or a keyboard input.

If the user determines there is an error in the image data, the hardcopy device 30 deletes the image data from the buffer (step 350). If there is an error in the image data acknowledged by the user submitting the print job, it is not necessary for the hardcopy device 30 to print the image data. By not printing the image data having the error, the wasteful consumption of paper or toner by the hardcopy device 30 can be reduced. If the user determines there is an error in the image data, the user may resubmit the print job. Alternatively, the print job may be resubmitted automatically in response to the indication from the user that there is an error in the image data.

If, however, the user determines there is no error in the image data, the image data is printed (step 355). The image data is printed in the same manner as described above. In particular, the control system 220 transfers the image data to the printer system 250 from the buffer, which processes the image data into a print image to be printed on one or more sheets. The paper supply 260 supplies each sheet, and the printer system places the print image on the supplied sheet. The paper discharge 270 controls the output of each printed sheet to an output portion of the hardcopy device 30.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for printing image data at a hardcopy device, comprising:
receiving the image data to be printed from a user;
determining if the received image data has at least one predetermined error;
notifying the user if the received image data is determined to have at least one predetermined error; and
receiving an indication from the user whether to print the image data in response to the notification to the user.

2. A method according to claim 1, further comprising storing the image data in a buffer if the image data is determined to have at least one predetermined error.

3. A method according to claim 2, further comprising deleting the image data from the buffer based on the received indication.

4. A method according to claim 1, further comprising printing the image data if:
the indication received from the user approves the printing of the image data; or
the image data has no predetermined errors.

5. A method according to claim 1, wherein the image data has at least one predetermined error if the image data is either all black data or all white data.

6. A method according to claim 1, wherein the image data has at least one predetermined error if the image data includes multiple consecutive page breaks.

7. A method according to claim 1, wherein the image data has at least one predetermined error if a predetermined number of pages in the image data each include fewer than a predetermined number of characters.

8. A method according to claim 1, further comprising identifying the at least one error in the notification to the user.

9. A computer readable medium operable on a computer system configured to print image data at a hardcopy device, the computer readable medium configured to:
receive the image data to be printed from a user;
determine if the received image data has at least one predetermined error;
notify the user if the received image data is determined to have at least one predetermined error; and
receive an indication from the user whether to print the image data in response to the notification to the user.

10. A computer readable medium according to claim 9, further configured to store the image data in a buffer if the image data is determined to have at least one predetermined error.

11. A computer readable medium according to claim 10, further configured to delete the image data from the buffer based on the received indication.

12. A computer readable medium according to claim 9, further configured to print the image data if:
the indication received from the user approves the printing of the image data; or
the image data has no predetermined errors.

13. A computer readable medium according to claim 9, wherein the image data has at least one predetermined error if the image data is either all black data or all white data.

14. A computer readable medium according to claim 9, wherein the image data has at least one predetermined error if the image data includes multiple consecutive page breaks.

15. A computer readable medium according to claim 9, wherein the image data has at least one predetermined error if a predetermined number of pages in the image data each include fewer than a predetermined number of characters.

16. A computer readable medium according to claim 9, further configured to identify the at least one error in the notification to the user.

17. A hardcopy device for printing image data, the hardcopy device comprising:
a processor;
a memory, coupled to the processor, the memory comprising a plurality of instructions executed by the processor, the plurality of instructions configured to:
receive the image data to be printed from a user;
determine if the received image data has at least one predetermined error;
notify the user if the received image data is determined to have at least one predetermined error; and
receive an indication from the user whether to print the image data in response to the notification to the user.

18. A hardcopy device according to claim 17, the memory further comprising an instruction configured to store the image data in a buffer if the image data is determined to have at least one predetermined error.

19. A hardcopy device according to claim 18, the memory further comprising an instruction further configured to delete the image data from the buffer based on the received indication.

20. A hardcopy device according to claim 17, the memory further comprising an instruction further configured to print the image data if:
the indication received from the user approves the printing of the image data; or
the image data has no predetermined errors.

21. A hardcopy device according to claim 17, wherein the image data has at least one predetermined error if the image data is either all black data or all white data.

22. A hardcopy device according to claim 17, wherein the image data has at least one predetermined error if the image data includes multiple consecutive page breaks.

23. A hardcopy device according to claim 17, wherein the image data has at least one predetermined error if a predetermined number of pages in the image data each include fewer than a predetermined number of characters.

24. A hardcopy device according to claim 17, the memory further comprising an instruction further configured to identify the at least one error in the notification to the user.
